(19) United States
(12) Patent Application Publication
(10) Pub. No.: US 2005/0186394 A1
(43) Pub. Date: Aug. 25, 2005

(54) Plastic sheet

(76) Inventor: Chou-Huie Yang, Nan-Tou City (TW)

Correspondence Address: LADAS & PARRY LLP, 224 SOUTH MICHIGAN AVENUE, SUITE 1600, CHICAGO, IL, 60604, US

(21) Appl. No.: 10/782,477

(22) Filed: Feb. 19, 2004

(51) Int. Cl. B32B 3/00

(52) U.S. Cl. 428/156

(57) ABSTRACT

A plastic sheet includes a substrate having a surface formed with a plurality of embossed recess portions proximate to each other. Each of the embossed recess portions is confined by a flat bottom wall and a side wall that extends from the flat bottom wall to the surface. The plastic sheet has physical properties, such as improved breaking strength, stretching strength, and tearing strength.

### BACKGROUND OF THE INVENTION

1. Field of the Invention

The invention relates to a plastic sheet, more particularly to a plastic sheet having a plurality of embossed recess portions.

2. Description of the Related Art

In a conventional process for manufacturing a plastic sheet roll, a plastic material is calendered to form a plastic sheet, which is then embossed so as to form an embossed pattern on an outer surface facing away from an axis of the plastic sheet roll. Since an inner surface facing toward the axis of the plastic sheet roll is not embossed and is thus smooth, the outer and inner surfaces of the plastic sheet roll are liable to adhere to each other. Therefore, the plastic sheet is likely to deform when it is unwound from the plastic sheet roll.

In order to solve the aforesaid problem, another conventional plastic sheet is formed with embossed inner and outer surfaces. Referring to FIGS. 1 and 2, the plastic sheet 1 has an outer surface 101 facing away from an axis of a plastic sheet roll (not shown) and an inner surface 102 opposite to the outer surface 101. The inner and outer surfaces 102, 101 are embossed, in which the inner surface 102 is embossed to form an array of recesses 105 that are spaced apart from each other. Each of the recesses 105 is formed in a shape of an inverted pyramid.

Although the conventional plastic sheet 1 solves the aforesaid adhering problem through the embossing of two surfaces thereof, it still has the following shortcomings:

1. Referring to FIGS. 3 and 4, since each of the recesses 105 is formed in the shape of a pyramid, the sharp edges thereof can destroy the molecular structure of the polymer molecules constituting the plastic sheet 1.

2. Referring again to FIG. 2, the thickness of the plastic sheet 1 is decreased gradually from side edges of the pyramid toward the tip of the pyramid. When the plastic sheet 1 is unwound from a plastic sheet roll, it is liable to tear at parts where the thickness is smallest. Therefore, the physical properties (such as the stretching strength, the tearing strength, and the breaking strength) of the plastic sheet 1 are insufficient.

### SUMMARY OF THE INVENTION

Therefore, the object of the present invention is to provide a plastic sheet having improved physical properties.

According to one aspect of this invention, a plastic sheet includes a substrate having a surface formed with a plurality of embossed recess portions proximate to each other. Each of the embossed recess portions is confined by a flat bottom wall and a side wall that extends from the flat bottom wall to the surface.

According to another aspect of this invention, a plastic sheet roll includes a plastic sheet wound around an axis to form a roll. The sheet has an outer surface facing away from the axis, and an inner surface opposite to the outer surface and formed with a plurality of embossed recess portions proximate to each other. Each of the embossed recess portions is confined by a flat bottom wall and a side wall that extends from the flat bottom wall to the inner surface.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic planar view of a conventional plastic sheet;

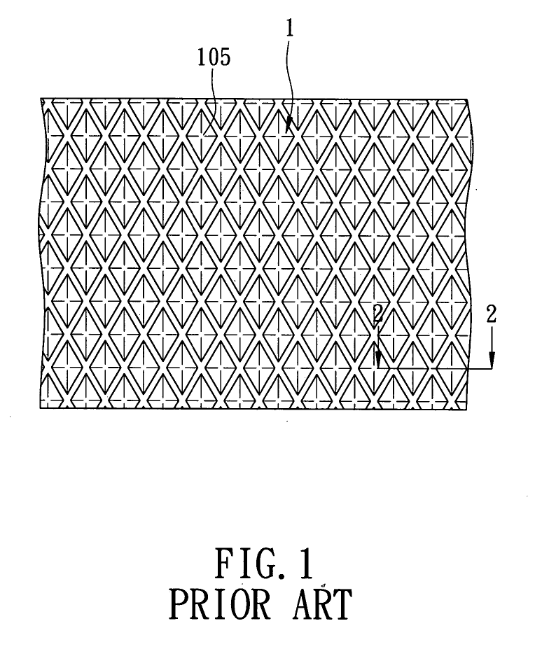

FIG. 2 is a fragmentary sectional view of the conventional plastic sheet of FIG. 1 taken along line 2-2 in FIG. 1;

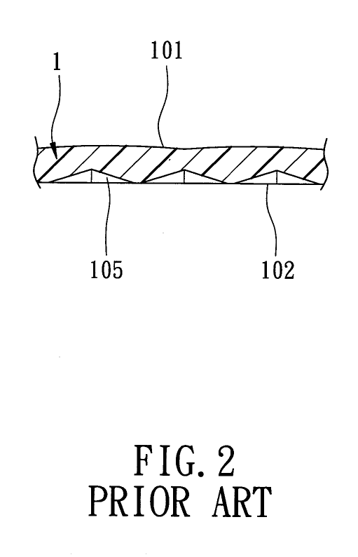

FIG. 3 is a schematic view showing a relationship between an embossed recess and molecular structures of the plastic sheet of FIG. 1;

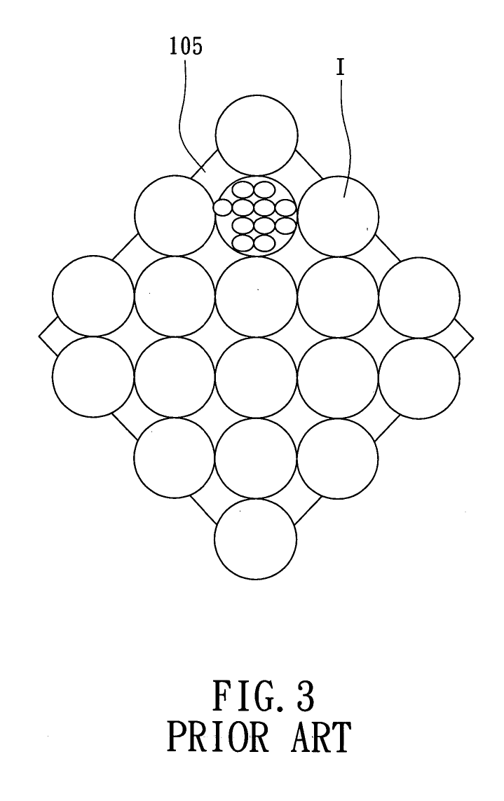

FIG. 4 is a schematic view showing a stretching state of a plastic sheet of FIG. 1;

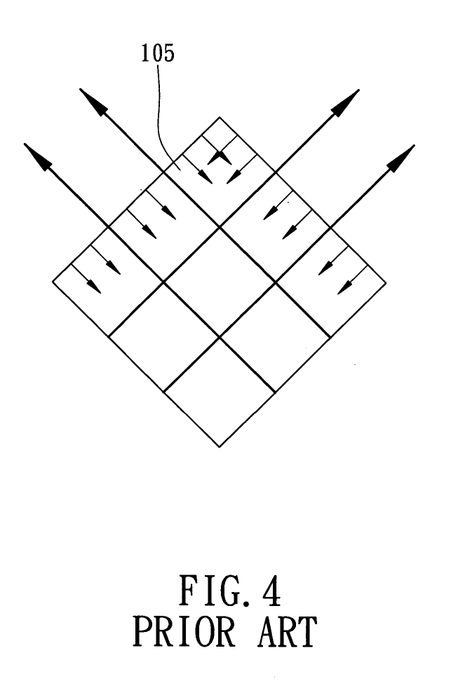

FIG. 5 is a fragmentary schematic planar view of the preferred embodiment of a plastic sheet according to this invention;

FIG. 6 is a fragmentary sectional view of the plastic sheet of FIG. 5 taken along line 6-6 in FIG. 5;

FIG. 7 is a schematic view showing a relationship between an embossed recess and molecular structures of the plastic sheet of FIG. 5; and

FIG. 8 is a schematic view showing a stretching state of the plastic sheet of FIG. 5.

### DETAILED DESCRIPTION OF THE PREFERRED EMBODIMENTS

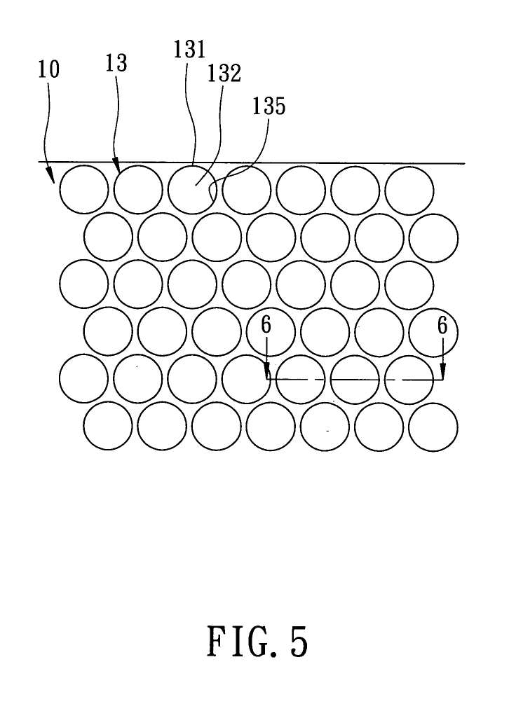

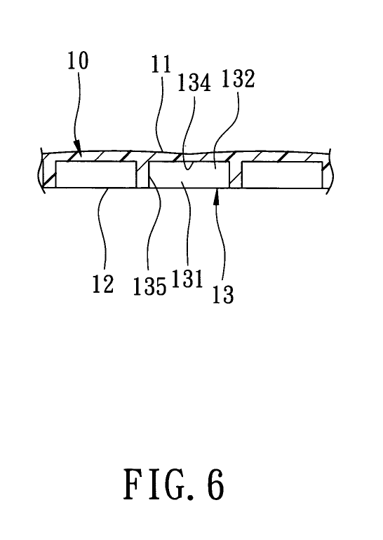

Referring to FIGS. 5 and 6, the preferred embodiment of a plastic sheet roll according to this invention is shown to include a plastic sheet 10 wound around an axis (not shown) to form a roll. The plastic sheet 10 includes a substrate having an outer surface 11 facing away from the axis, and an inner surface 12 opposite to the outer surface 11 and formed with a plurality of embossed recess portions 13 proximate to each other. Each of the embossed recess portions 13 is confined by a flat bottom wall 134 and a side wall 135 that extends from the flat bottom wall 134 to the inner surface 12 so as to define a recess 132 having an opening 131. In the preferred embodiment, the side wall 135 of each of the embossed recess portions 13 has a circular-shaped cross-section. Alternatively, the side wall 135 of each of the embossed recess portions may have other suitable rounded cross-sections, such as an elliptical-shaped cross-section. Furthermore, the embossed recess portions 13 have the same depth, and the side walls 135 of the embossed recess portions 13 are in contact with each other.

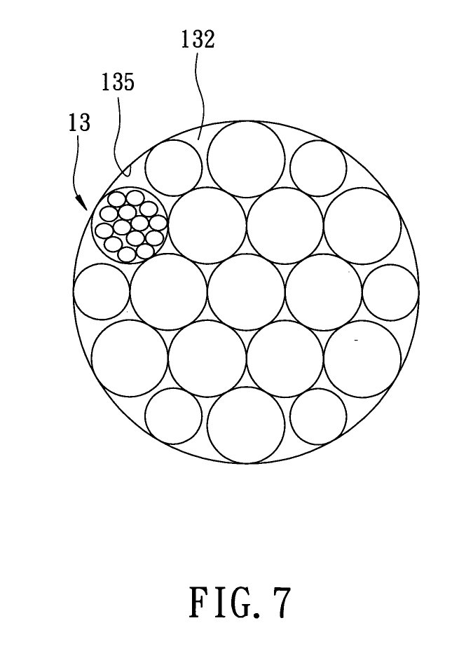

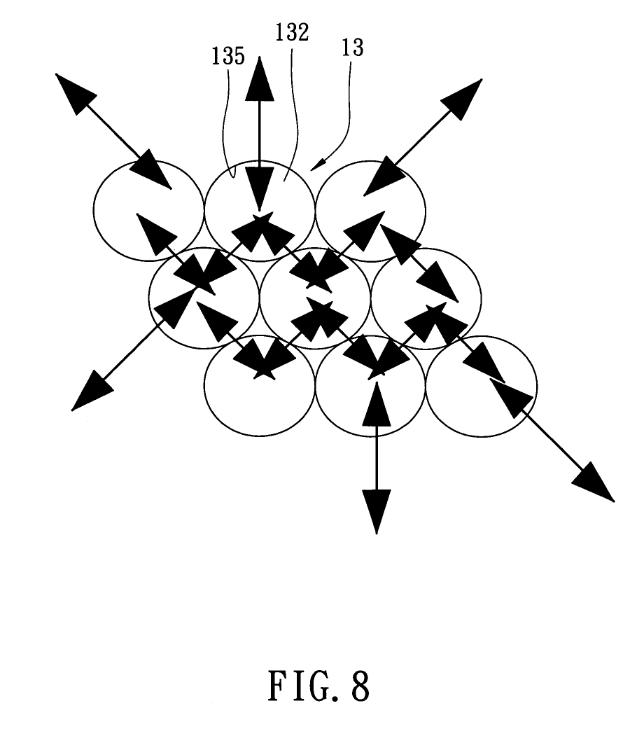

Referring further to FIGS. 7 and 8, since the side wall 135 of each of the embossed recess portions 13 has a circular-shaped cross-section which conforms to the molecular structure of the polymer molecules that constitute the plastic sheet 10, the strength of the plastic sheet 10 is improved. Furthermore, since the embossed recess portions 13 have the same depth, the thickness between the flat bottom wall 134 of each of the embossed recess portions 13 and the outer surface 11 is maintained. Therefore, the risk of tearing encountered in the aforesaid prior art due to the decreasing thickness can be reduced. The physical properties, such as the stretching strength, the tearing strength, and the breaking strength, of the plastic sheet 10 are thus be improved.

The following table shows the test results of the burst strength between the plastic sheet 1 of the prior art and the plastic sheet 10 of this invention.

TABLE 1

| | The prior art | | | This invention | | |
|---|---|---|---|---|---|---|
| | Time | | Depth | Time | | Depth |
| | till | Loading | till | till | Loading | till |
| | rupture | force | rupture | rupture | force | rupture |
| Run # | (sec) | (kg) | (mm) | (sec) | (kg) | (mm) |
| 1 | 52 | 5 | 2.2 | 59 | 5.6 | 2.5 |
| 2 | 55 | 5.2 | 2.3 | 59 | 5.5 | 2.5 |
| 3 | 52 | 5.1 | 2.2 | 59 | 5.8 | 2.5 |
| 4 | 55 | 5.4 | 2.3 | 58 | 5.6 | 2.4 |
| 5 | 52 | 5.2 | 2.2 | 59 | 5.6 | 2.5 |

It is evident from the test results of Table 1 that the time till rupture for the plastic sheet 10 of this invention is longer than that for the plastic sheet 1 of the prior art even though the loading force applied on the plastic sheet 10 of this invention is heavier than that of the plastic sheet 1 of the prior art. This means that the burst strength of the plastic sheet 10 of this invention is superior to that of the plastic sheet 1 of the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A plastic sheet comprising:
a substrate having a surface formed with a plurality of embossed recess portions proximate to each other, each of said embossed recess portions being confined by a flat bottom wall and a side wall that extends from said flat bottom wall to said surface.

2. The plastic sheet as claimed in claim 1, wherein said side wall of each of said embossed recess portions has a circular-shaped cross-section.

3. The plastic sheet as claimed in claim 1, wherein said flat bottom wall of each of said embossed recess portions has an elliptical-shaped cross-section.

4. The plastic sheet as claimed in claim 1, wherein said embossed recess portions have the same depth.

5. The plastic sheet as claimed in claim 1, wherein said side walls of said embossed recess portions are in contact with each other.

6. The plastic sheet as claimed in claim 1, wherein said side wall of each of said embossed recess portions has a rounded cross-section.

7. A plastic sheet roll, comprising:
a plastic sheet wound around an axis to form a roll, said sheet having an outer surface facing away from said axis, and an inner surface opposite to said outer surface and formed with a plurality of embossed recess portions proximate to each other, each of said embossed recess portions being confined by a flat bottom wall and a side wall that extends from said flat bottom wall to said inner surface.

8. The plastic sheet roll as claimed in claim 7, wherein said side wall of each of said embossed recess portions has a circular-shaped cross-section.

9. The plastic sheet roll as claimed in claim 7, wherein said flat bottom wall of each of said embossed recess portions has an elliptical-shaped cross-section.

10. The plastic sheet roll as claimed in claim 7, wherein said embossed recess portions have the same depth.

11. The plastic sheet roll as claimed in claim 7, wherein said side walls of said embossed recess portions are in contact with each other.

12. The plastic sheet roll as claimed in claim 7, wherein said side wall of each of said embossed recess portions has a rounded cross-section.
